(19) United States
(12) Patent Application Publication
(10) Pub. No.: US 2013/0151761 A1
(43) Pub. Date: Jun. 13, 2013

(54) DATA STORAGE DEVICE STORING PARTITIONED FILE BETWEEN DIFFERENT STORAGE MEDIUMS AND DATA MANAGEMENT METHOD

(71) Applicants: MIN-KWON KIM, HWASEONG-SI (KR); KI-WON LEE, SEOUL (KR); SEOKHEON LEE, SUWON-SI (KR); SEONGYONG LEE, SEOUL (KR); JAE-BUM LEE, YONGIN-SI (KR)

(72) Inventors: MIN-KWON KIM, HWASEONG-SI (KR); KI-WON LEE, SEOUL (KR); SEOKHEON LEE, SUWON-SI (KR); SEONGYONG LEE, SEOUL (KR); JAE-BUM LEE, YONGIN-SI (KR)

(73) Assignee: SAMSUNG ELECTRONICS CO., LTD., SUWON-SI (KR)

(21) Appl. No.: 13/604,704

(22) Filed: Sep. 6, 2012

(30) Foreign Application Priority Data
Dec. 8, 2011 (KR) 10-2011-0131169

(51) Int. Cl. G06F 12/02; G06F 12/14

(52) U.S. Cl. 711/103; 711/165; 711/164; 711/E12.008; 711/E12.002; 711/E12.094

(57) ABSTRACT

A data management method for a data storage device includes receiving a write request; partitioning the file into first and second portions; encrypting the first portion, and storing the encrypted first portion in a first storage medium and the second portion in a second storage medium.

### CROSS-REFERENCE TO RELATED APPLICATIONS

A claim for priority under 35 U.S.0 §119 is made to Korean Patent Application No. 10-2011-0131169 filed Dec. 8, 2011, the subject matter of which is hereby incorporated by reference.

### BACKGROUND

The inventive concept relates to electronic devices including a data storage device. More particularly, the inventive concept relates to data storage devices including nonvolatile memory used as a cache memory and data management methods for such data storage devices.

Modern digital logic system and consumer electronics are characterized by a seemingly endless demand for greater data storage capacity and faster data access speeds. In particular, mobile electronic devices demand reduced power consumption, lighter weight, greater portability and improved endurance. Such demands significantly affect the design and use of various auxiliary data storage devices.

In response to these and other market demands, the data storage capacity of hard disk based data storage device has rapidly increased due to improvements in related fabrication technologies. Hard Disk Drives (HDD) have been widely used as auxiliary storage devices for many years, but in certain applications are steadily being replaced by Solid State Drives (SSD).

In the main, the SSD is a NAND flash-based, next-generation storage device that is increasingly used as a high-end auxiliary storage device. Since it is formed of NAND flash memories, the SSD does not require the use of mechanical components (e.g., rotary magnetic disk or platter, actuator, read/write head, etc.) like conventional HDD. Nonetheless, the SSD is a very competent bulk data storage device exhibiting the desired characteristics of low power consumption, high data access speeds, better immunity to mechanical shock, low noise generation, excellent endurance, portability, and the like. Compared with a magnetic disk-type HDD, the SSD suffers few contemporary disadvantages such as storage capacity and cost. Further, continuing advances in process and design technologies may enable the storage capacity of the SSD to increase while reducing overall fabrication costs. Yet, for at least the near term, the SSD will not surpass the HDD in terms of a cost/capacity ratio.

The so-called “hybrid HDD” has been proposed in recent years that draws upon advantages from both the HDD and SSD. The hybrid HDD includes a HDD and a nonvolatile memory (e.g., a SSD) used as a HDD cache. With this configuration the hybrid HDD provides high-speed data access characteristics due to reduced disk operations, while also providing bulk data storage capabilities. The hybrid HDD effectively reduces boot time, power consumption, device heating, system noise, and extends the life of a storage device.

### SUMMARY

Embodiments of the inventive concept provide a data management method for a data storage device includes a plurality of storage mediums. In one embodiment, the data management method comprises; receiving a write request and a corresponding write-requested file from a host, partitioning the write-requested file into a first portion and a second portion, and storing the first portion in the first storage medium and storing the second portion in the second storage medium. The first portion may be a header of the write-requested file, and the first portion may be encrypted before storing the first portion in the first storage medium.

In another embodiment, the inventive concept provides a data storage device comprising; a nonvolatile cache including a nonvolatile memory device and a memory controller controlling the nonvolatile memory device, a disk storage device including a magnetic disk, and a data path controller that receives and partitions a write-requested file into a first portion and a second portion, and then, encrypts the first portion, stores the encrypted first portion in the nonvolatile cache using a first addressing scheme, and stores the second portion in the disk storage device using a second addressing scheme different from the first addressing scheme.

In yet another embodiment, the inventive concept provides a data storage device comprising; a plurality of storage mediums, and a data path controller controlling the plurality of storage mediums to write a first portion of a write-requested file in a first storage medium using a first addressing scheme and independently write a second portion of the write-requested file in a second storage medium using a second addressing scheme, wherein the first portion is encrypted before being written in the first storage medium.

### BRIEF DESCRIPTION OF THE FIGURES

The above and other objects and features will become apparent from the following description with reference to the accompanying drawings.

FIG. 1 is a block diagram describing a data managing method of a data storage device according to an embodiment of the inventive concept.

FIG. 2 is a block diagram illustrating the software architecture of a user device in FIG. 1.

FIG. 3 is a block diagram illustrating a data storage device according to an embodiment of the inventive concept.

FIG. 4 is a block diagram illustrating a data path controller in FIG. 3 according to an embodiment of the inventive concept.

FIG. 5 is a block diagram illustrating an NVM cache in FIG. 3 according to an embodiment of the inventive concept.

FIG. 6 is a block diagram illustrating an encryption engine in FIG. 5.

FIG. 7 is a flowchart illustrating a data managing method of a data path controller 1210a according to an embodiment of the inventive concept.

FIG. 8 is a diagram describing data flow according to a data managing method in FIG. 7.

FIG. 9 is a flowchart describing a data managing method of a data path controller in FIG. 3 according to another embodiment of the inventive concept.

FIG. 10 is a diagram describing data flow according to a data managing method in FIG. 9.

FIG. 11 is a block diagram illustrating a data storage device according to another embodiment of the inventive concept.

FIG. 12 is a block diagram illustrating an NVM controller and an NVM in FIG. 11.

FIG. 13 is a flowchart describing a data managing method of an NVM controller in FIG. 12.

FIG. 14 is a block diagram a user device according to another embodiment of the inventive concept.

FIG. 15 is a block diagram illustrating the software architecture of a user device in FIG. 14.

FIG. 16 is a table describing one file partition method executed by a file system or a device driver in FIG. 14.

FIG. 17 is a block diagram illustrating the software architecture of a user device in FIG. 16 according to another embodiment of the inventive concept.

FIG. 18 is a block diagram illustrating a computing system including a data storage device according to embodiments of the inventive concept.

### DETAILED DESCRIPTION

The inventive concept will now be described in some additional detail with reference to the accompanying drawings. The inventive concept may, however, be embodied in many different forms and should not be construed as being limited to the illustrated embodiments. Rather, these embodiments are provided so that this disclosure will be thorough and complete, and will fully convey the scope of the inventive concept to those skilled in the art. Throughout the written description and drawings like reference numbers and labels will be used to denote like or similar elements.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

The terminology used herein is for the purpose of describing portion icular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

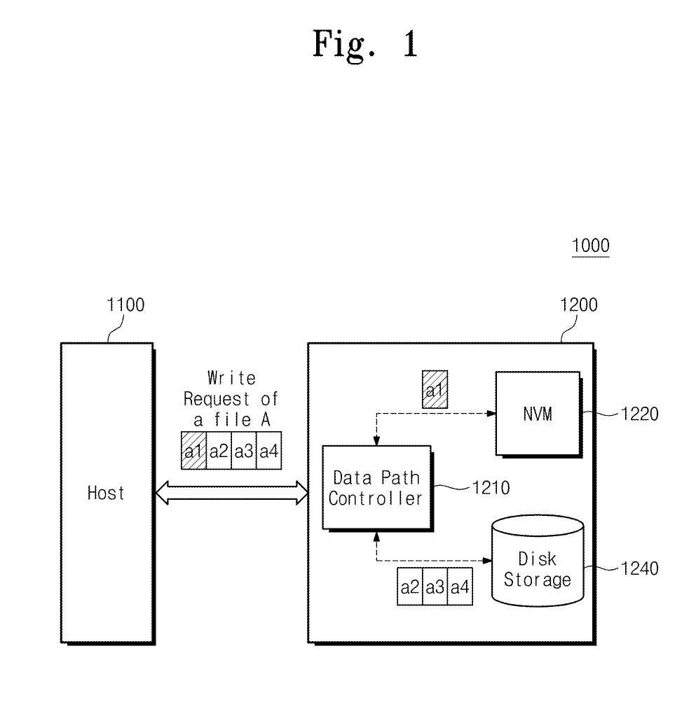

Figure (FIG.) 1 is a block diagram illustrating a data storage device operating in accordance with an embodiment of the inventive concept. Referring to FIG. 1, a user device 1000 generally comprises a host 1100 and a data storage device 1200. In order to store very large quantities of “bulk” data, the data storage device 1200 of FIG. 1, includes a nonvolatile memory 1220 implemented with one or more semiconductor memory devices and a disk storage 1240 including a magnetic disk as a storage medium.

The user device 1000 may be an information processing device such as a personal computer, a digital camera, a camcorder, a handheld phone, an MP3 player, a PMP, a PDA, or the like. The host 1100 may include a volatile memory such as DRAM, SRAM, or the like and a nonvolatile memory device such as EEPROM, FRRAM, PRAM, MRAM, flash memory, or the like.

The host 1100 may be configured to generate and delete files during the execution of various applications and programs. The generation and/or deletion of files may be controlled by a file system operating within the host 1100.

That is, the host 1100 may generate a file and issue a corresponding write-file request to the data storage device 1200. The generated file may then be transferred to the data storage device 1200 (e.g., in relation to one or more sector address(es) provided by the host 1100, or on a sector basis). A write-file request or similar transaction between the host 1100 and data storage device 1200 may be generated as a cluster.

With reference to FIG. 1, for example, it is assumed that writing a file A to the data storage device 1200 is requested by the host 1100. It is further assumed that file A includes four (4) sectors a1, a2, a3, and a4, where sector a1 is a file header and sectors a2, a3, and a4 collectively form a file body.

Upon writing the file A to the data storage device 1200, the data storage device 1200 may discriminate the file header from the file body and respectively store these “file portions” in different storage mediums. For example, sector a1—corresponding to the file header and being relatively small in size—may be stored in the nonvolatile memory device 1220, while sectors a2, a3, and a4—corresponding to the file body and being relatively large in size—may be stored in the disk storage 1240.

The data storage device 1200 of FIG. 1 further comprises a data path controller 1210. The data path controller 1210 may be configured to divide (or partition) a write-requested file into a plurality of write-requested file portions and then control the different write-requested file portions in different storage mediums. The data path controller 1210 may be further configured to merge related write-file requested file portions during a subsequent read operation directed to the file. Further, asymmetrical encoding may be performed to one of the write-requested file portions (e.g., the file header, sector a1), or a similar or different encoding may be performed for each one of the write-requested file portions.

Because certain embodiments of the inventive concept, such as the one illustrated in FIG. 1, store different portions of a single file (or “unitary file”—as defined by the file system of the host 1100) in different storage mediums, it is impossible to effectively hack the file by hacking one of the different storage mediums. Hence, data security is improved. And if different write-requested file portions are respectively encoded using different security keys, it is additionally difficult to hack the file.

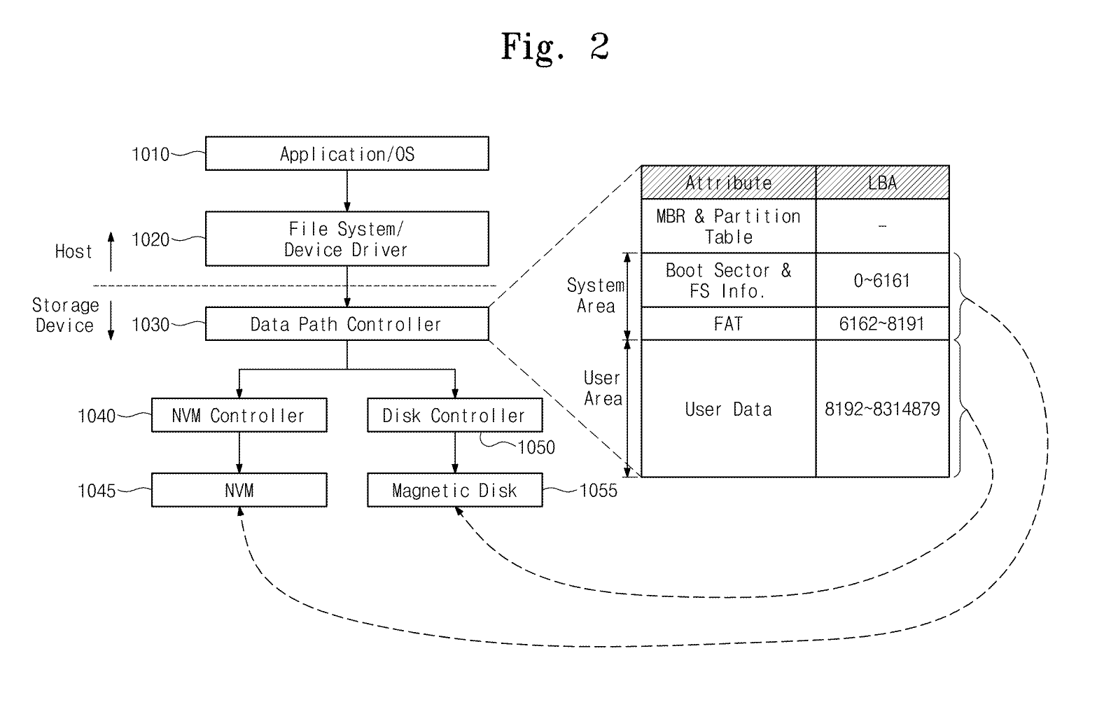

FIG. 2 is a conceptual block diagram illustrating one possible software architecture that may be used by the user device 1000 of FIG. 1. Referring to FIG. 2, software controlling the generation and handling of a file by the user device 1000 may be hierarchically divided into higher level layer(s) and a lower level layer(s). Higher level software layers may include an application program 1010 and a file system 1020 operating within the host 1100. Lower level layers may include software controlling the data path controller 1030, nonvolatile memory (NVM) controller 1040, nonvolatile memory 1045, disk controller 1050, and magnetic disk 1055.

In the illustrated embodiment of FIG. 2, the application program 1010 operates at the highest level of the software architecture and drives the user device 1000. The application program 1010 may be a program that is designed to enable a user or another application to directly perform a specific function. The application program 1010 may operate in conjunction with an operating system (OS) or other support programming. Access to the data stored in the data storage device 1200 may be requested by the application program 1010 and/or the operating system OS.

The file system 1020 may be a set of abstract database structures for hierarchically storing, searching, accessing, and operating a database. For example, Microsoft Windows® driving a personal computer may use FAT or NTFS as the file system 1020. The file system 1020 may generate, delete, and manage data on a file unit basis.

The data path controller 1030 may be used to process a write request on a file unit basis as issued by the file system 1020. In response to the write request designating a write-requested file, the data path controller 1030 may be used to portion the write-requested file received from the host 1100 in conjunction with the write request into two file portions. Then, the data path controller 1030 may write one file portion using the NVM controller and the NVM 1045, and the other file portion using the disk controller 1050 and the magnetic disk 1055.

In response to a subsequently received read request from the host 1100, the data path controller 1030 may similarly partition information (e.g., data and/or address information) related to the read-requested file so that it may be respectively used to retrieve the file portions using the NVM 1045 and magnetic disk 1055. Then, the data path controller 1030 may merge the two retrieved file portions obtained from the nonvolatile memory 1045 and the magnetic disk 1055 to provide a resulting read-request file to the host 1100.

To manage a file as described above, the data path controller 1030 may conduct memory management like a memory map as conceptually illustrated in FIG. 2 in relation to the given software architecture. That is, data corresponding to a system area may be assigned to the nonvolatile memory 1045, and data corresponding to a user area may be assigned to the magnetic disk 1055. Data to be stored in the user area and data to be stored in the system area may be discriminated using various attributions. For example, based on a particular data attribute, data may be assigned a set of logical addresses (LBA) by the host 1100 or file system 1020. Thus, the data path controller 1030 may store metadata LBA0 to LBA6161 corresponding to boost sector and system information and metadata LBA6162 to LBA8191 corresponding to a file allocation table (FAT) using the nonvolatile memory 1045. The data path controller 1030 may store data LBA8192 to LBA8314879 corresponding to the user area using the magnetic disk 1055.

In this regard, the NVM controller 1040 may convert an address suitable for the nonvolatile memory 1045 in response to a read/write request by the data path controller 1030. For example flash memory forming the nonvolatile memory 1045 may not support a direct overwrite operation, but may require an erase operation before writing. A flash translation layer (FTL) may be used between a file system 1020 and a flash memory to essentially hide this operational requirement. Thus, in certain embodiments of the inventive concept, the NVM controller 1040 may include a FTL.

During a write operation executed by the nonvolatile memory 1045, the FTL may map a logical address provided by the file system 1020 onto a physical address for the flash memory so that an erase operation may be performed. The FTL may use an address mapping table to perform a fast address mapping operation.

The NVM controller 1040 may write data provided through the data path controller 1030 to the nonvolatile memory 1045. Additionally, all or portion of the data in a write-requested file may be encoded using a security key. The NVM controller 1040 may provide the data path controller 1030 with read-requested data. As a result, metadata LBA0 to LBA8191 corresponding to a system area of the memory map may be stored using the nonvolatile memory 1045.

The disk controller 1050 may write data provided through the data path controller 1030 to the magnetic disk 1055. The disk controller 1050 may retrieve read-requested data from the magnetic disk 1055 and provide it to the data path controller 1030. As a result, data LBA8192 to LBA8314879 corresponding to the user area may be stored in the magnetic disk 1055.

During a read request, the file portions will be merged by the data path controller 1030 before being provided to the host 1100. Hence, even where one file portion is hacked or otherwise becomes security compromised, it is quite difficult to obtain meaningful file information because corresponding portion(s) of the same file are differently stored in one or more different storage medium(s). Thus, it is possible to improve data security using an embodiment of the inventive concept like the data storage device 1200 of FIG. 1.

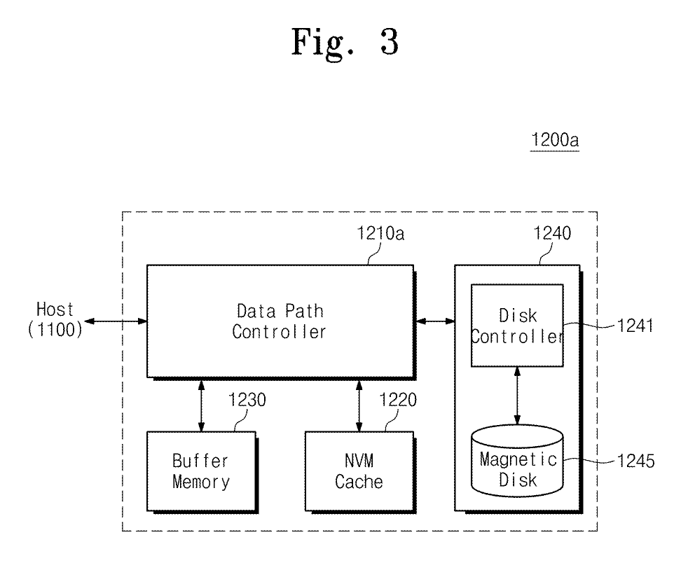

FIG. 3 is a block diagram further illustrating the data storage device 1200 of FIG. 1 according to an embodiment of the inventive concept. Referring to FIG. 3, the data storage device 1200a comprises a data path controller 1210a, a buffer memory 1230, an NVM cache 1220, and disk storage 1240.

The data path controller 1210a may perform the functions described with reference to FIG. 2, as enabled (e.g.,) by the data path controller software 1030. The data path controller 1210a may be used to decode a write-file request received from the host 1100. The file system 1020 of the host 1100 may assign a file name and a file size to the write-requested file. In particular, the file system 1020 may generate metadata defining, controlling and/or managing the write-requested file or portions thereof. In certain embodiments, the metadata may be included in a file header. The data path controller 1210a may store the write-requested file provided from the host 1100 using a plurality of data transactions with the buffer memory 1230. During this process, for example, the data path controller 1210a may effectively partition the write-requested file in the buffer memory 1230 using a predetermined file partition strategy. Thereafter, (assuming only two (2) post-partition file portions) the data path controller 1210a may store one portion of the write-requested file in the NVM cache 1220 and the other file portion in the disk storage 1240.

The data path controller 1210a may also be used to determine respective data paths for each file portion. Thus, the data path controller 1210a must partition the write-requested file in manner that allows a subsequent identification of relevant file portions stored data in the NVM cache 1220 and/or the disk storage 1240. A particular file portion strategy may be implemented through functionality resident in the data path controller 1210a, but is not limited thereto. For example, a file partition strategy may be controlled by reference to a file header or metadata stored in the disk storage 1240 and/or the NVM cache 1220.

The NVM cache 1220 may be formed of flash memory or other type of nonvolatile memory (e.g., NOR flash memory, fusion memory such as the OneNAND® flash memory) that is capable of retaining stored data in the absence of applied power. Further, the NVM cache 1220 may be configured to encode data using a security key.

The buffer memory 1230 may be used to store a command queue corresponding to an access request received from the host 1100. The buffer memory 1230 may alternately or additionally be used to temporarily store write data or read data. Data transferred from the NVM cache 1220 or the disk storage 1240 during a read operation may be temporarily stored in the buffer memory 1230. After being rearranged (e.g., merged) into a file at the buffer memory 1230, read data may be transferred to the host 1100. During a write request, data from a write-requested file may be stored in the buffer memory 1230 as partitioned file portions under the control of the data path controller 1210a. Thereafter, one file portion may be written to the NVM cache 1230, and the other file portion may be written to the disk storage 1240.

A data transfer speed of a bus format (e.g., SATA or SAS) of the host 1100 may be much higher than a data transfer speed between the data path controller 1210a and the NVM cache 1220 or between the data path controller 1210a and the disk storage 1240. That is, in case that an interface speed of the host 1100 is much higher thereby potentially reducing system performance, said speed difference may be compensated by providing a high-capacity buffer memory 1230.

The disk storage 1240 may record data, provided according to the control of the data path controller 1210a, at a magnetic disk 1245. The disk storage 1240 may include a disk controller 1241 and a magnetic disk 1245. Write-requested data may be recorded at the magnetic disk 1245 included in the disk storage 1240 by a sector unit. The disk storage 1240 may include a head recording or reading data in response to the control of the data path controller 1210a. The disk storage 1240 may include a motor for rotating the magnetic disk 1245 in a high speed. A general magnetic disk storage device may include one or more magnetic disks 1245 mounted on one spindle, and one head may be provided on each surface of the magnetic disk 1245. A surface of the magnetic disk 1245 may be divided into concentric circles marked by a track of a magnetic head on a magnetic disk according to a plurality of tracks, that is, spindles. In this case, a cylinder may be formed of a plurality of tracks decided by a plurality of magnetic heads at the same time. A track may be further divided into a plurality of sectors, and one sector may be a minimum access unit.

A hard disk driver may access a magnetic disk using a local block address (hereinafter, referred to as LBA). In case of the LBA, a disk may be accessed using an address manner in which a sector of a disk is used as an access unit, not in a cylinder, head and sector (CHS) accessing manner. For example, with the LBA manner, a first sector may have a serial number of ‘1’, and a disk may be accessed using the serial number.

Thus, using the data storage device 1200a of FIG. 3, the data path controller 1210a may partition a write-requested file received from the host 1100 according to defined conditions or according to a partition strategy, wherein one file portion will be stored in the NVM cache 1220 and another file portion will be stored in the disk storage 1240. Thus, it is virtually impossible to obtain in an unauthorized manner meaningful file data. This is particularly the case when data security is enhanced by encoding at least one file portion stored in the NVM cache 1220 and/or the disk storage 1240.

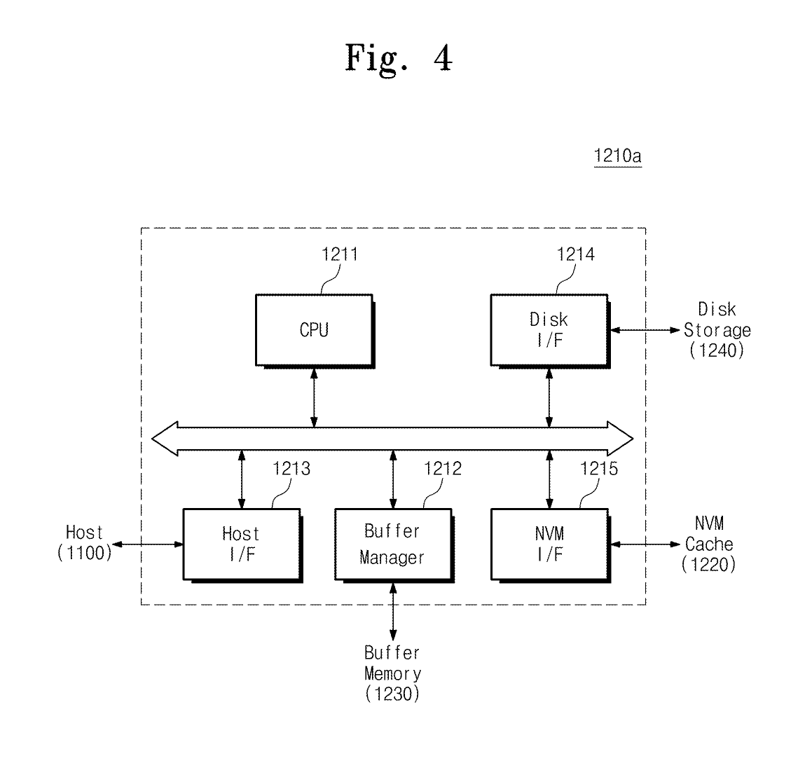

FIG. 4 is a block diagram illustrating the data path controller 1210a of FIG. 3 according to an embodiment of the inventive concept. Referring to FIG. 4, the data path controller 1210a comprises a Central Processing Unit (CPU) 1211, a buffer manager 1212, a host interface 1213, a disk interface 1214, and an NVM interface 1215.

The CPU 1211 may be used to provide various control information needed during read/write operation(s) to registers located in the host interface 1213, disk interface 1214, and/or NVM interface. For example, a command input from an external device may be stored in a register (not shown) of the host interface 1213. The host interface 1213 may inform the CPU 1211 that a read/write command is input, according to the stored command. This operation may be performed between the CPU 1211 and disk interface 1214, and between the CPU 1211 and NVM interface 1215. The CPU 1211 may control constituent elements according to firmware driving the storage device 1200.

The CPU 1211 may be used to partition data associated with a write-requested file into at least two (2) file portions in response to a write request received from the host 1100. After storing the write-requested file in a buffer memory 1230, the CPU 1211 may partition the stored file according to a file portion partition strategy. The CPU 1211 may then add data tag(s) indicating that the two file portions are associated with the unitary write-requested file received from the host 110. In this manner, the respective file portions and may be stored and retrieved from the NVM cache 1220 and/or the disk storage 1240.

In certain embodiments, the CPU 1211 may be a multi-core processor, and the data path controller 1210a may perform parallel processing using the multi-core CPU 1211. With parallel processing, the data path controller 1210a may operate with higher performance although being driven at a relatively slower clock.

The buffer manager 1212 may control read/write operations for the buffer memory 1230 of FIG. 3. For example, the buffer manager 1212 may temporarily store write data or read data in the buffer memory 1230.

The host interface 1213 may provide physical interconnection between a host and a user device 1000. That is, the host interface 1213 may provide an interface with a storage device 1200 to correspond to a bus format of a host. A host bus format may include IDE (Integrated Drive Electronics), EIDE (Enhanced IDE), USB (Universal Serial Bus), SCSI (Small Computer System Interface), PCI express, ATA, PATA (Parallel ATA), SATA (Serial ATA), SAS (Serial Attached SCSI), or the like. The disk interface 1214 may be configured to exchange data with the disk storage 1240 according to the control of the CPU 1211.

The NVM interface 1215 may exchange data with the NVM cache 1220. The NVM cache 1220 may be connected directly to the NVM interface 1215 without an interface means. In this case, the NVM cache 1220 may be formed of at least one nonvolatile memory device. The NVM interface 1215 may perform functions executed by a memory controller. For example, functions such as execution of FTL, channel interleaving, error correction, encoding, and the like may be made by the NVM interface 1215. In case that channel interleaving is made, the NVM interface 1215 may scatter data transferred from the buffer memory 1230 to memory channels, respectively. Read data provided from the NVM cache 1220 via memory channels may be combined by the NVM interface 1215. The combined data may be stored in the buffer memory 1230.

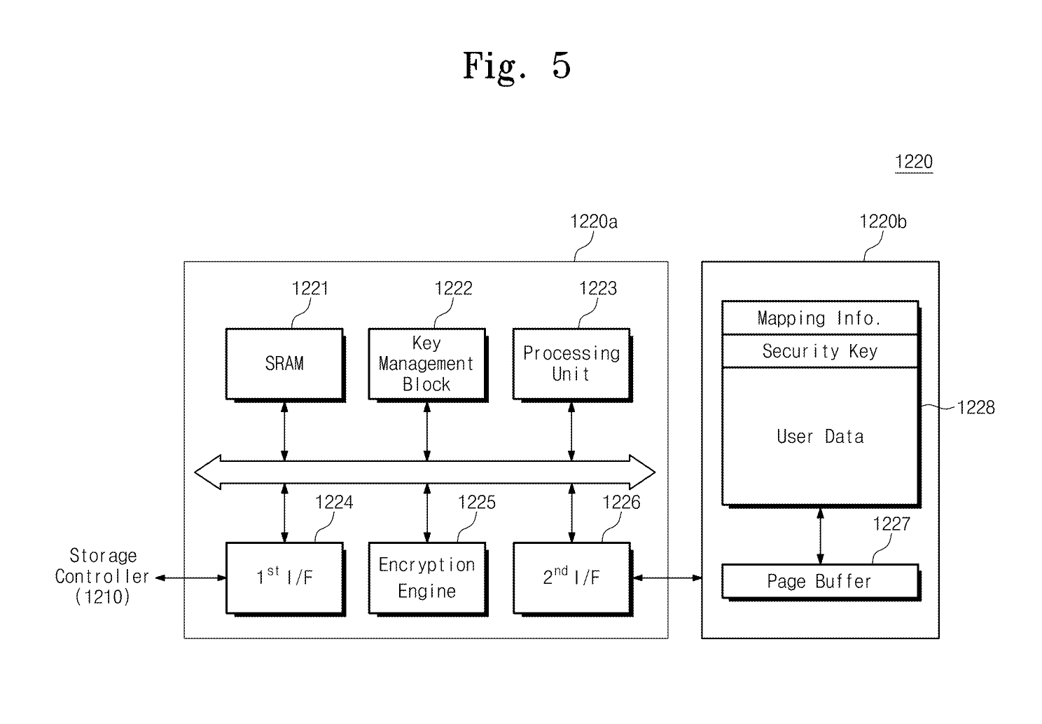

In certain embodiments, the NVM interface 1215 can be configured to perform simple data exchange with the NVM cache 1220 without functioning as a full memory controller. This possibility will be described in some additional detail with reference to FIG. 5. In such configurations, the NVM cache 1220 may further include a memory controller performing functions such as address mapping, wear-leveling, garbage collection, and the like. And the memory controller may also perform functions such as FTL execution, channel interleaving, error correction, encoding, and the like.

FIG. 5 is a block diagram further illustrating the NVM cache 1220 of FIG. 3 according to an embodiment of the inventive concept. Referring to FIG. 5, the NVM cache 1220 generally comprises a memory controller 1220a and a nonvolatile memory device 1220b.

The nonvolatile memory device 1220b may be formed of NAND flash memory, for example. The memory controller 1220a may be configured to control the nonvolatile memory device 1220b. The NVM cache 1220 may have a memory card form, a driver form, and a chip form by combination of the nonvolatile memory device 1220b and the memory controller 1220a.

The memory controller 1220a of FIG. 5 includes an SRAM 1221, a key management block 1222, a processing unit 1223, a first interface 1224, an encryption engine 1225, and a second interface 1226.

The SRAM 1221 may be used as a working memory of the processing unit 1223. The first and second interfaces 1224 and 1226 may provide the data exchange protocol between a data path controller 1210a and the nonvolatile memory device 1220b, respectively. The processing unit 1223 may perform memory management operations according to firmware. For example, the processing unit 1223 may perform a function of a flash translation layer (FTL) providing an interface between the nonvolatile memory device 1220b and the data path controller 1210a. To perform an address translation function being another function of the FTL, the processing unit 1223 may configure a mapping table on the SRAM 1221. The mapping table may be periodically updated at a mapping information area of the nonvolatile memory device 1220b under the control of the processing unit 1223.

The key management block 1222 may provide the encryption engine 1225 with a security key for encoding write-requested data in response to a write request from the data path controller 1210a. The key management block 1222 may read a security key from a security key storage area of the nonvolatile memory device 1220b based on an address provided at a write request of the data path controller 1210a. The key management block 1222 may read a security key from the security key storage area of the nonvolatile memory device 1220b in response to a read request of the data path controller 1210a, and may provide it to the encryption engine 1225.

The encryption engine 1225 may encode write-requested data or read-requested data based on a security key provided from the key management block 1222. The encryption engine 1225 may encode write-requested data using a security key provided from the key management block 1222, while the encryption engine 1225 may decode read-requested data using a security key provided from the key management block 1222. The encryption engine 1225 may be formed of the AES (Advanced Encryption Standard) algorithm or a device corresponding thereto, for example.

The memory controller 1220a may further include an ECC block (not shown) for detecting and correcting errors of data read from the nonvolatile memory device 1220b. Although not shown in figure, the memory controller 1220a according to the inventive concept may further include a ROM storing code data.

The nonvolatile memory device 1220b may include one or more flash memory devices. The nonvolatile memory device 1220b may include a cell array 1228 storing data and a page buffer 1227 writing or reading access-requested data. The cell array 1228 may include an area storing mapping information used to translate a logical address from the data path controller 1210a into a physical address of the nonvolatile memory device 1220b. The cell array 1228 may further include a security key area storing a security key for encryption. The cell array 1228 may further include a user data area storing write-requested data.

Hereinafter, certain embodiments of the inventive concept will be described under an assumption that the nonvolatile memory device 1220b is a NAND flash memory. However, the inventive concept is not limited thereto. For example, the nonvolatile memory device 1220b can be formed of a PRAM, an MRAM, a ReRAM, an FRAM, a NOR flash memory, or the like.

The above-described NVM cache 1220 is merely one possible example, and may be variously configured to functionally incorporate a fusion flash memory such as the OneNAND® flash memory.

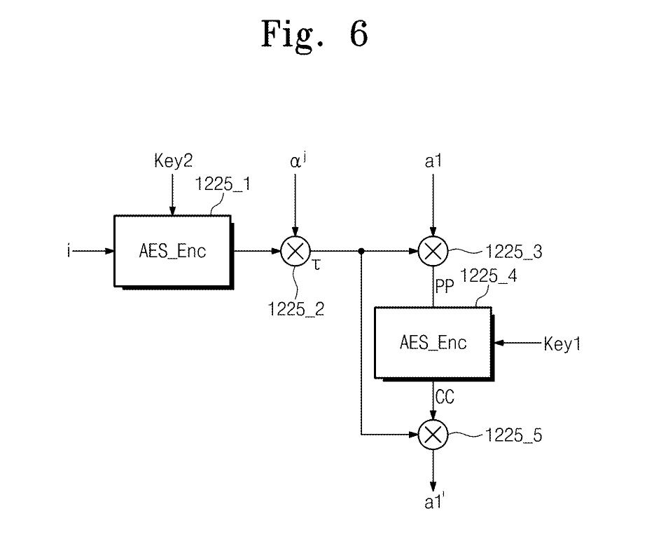

FIG. 6 is a block diagram further illustrating the encryption engine 1225 of FIG. 5. Referring to FIG. 6, the encryption engine 1225 comprises a first encryption unit 1225_1, a modulo multiplexer 1225_2, an XOR gate 1225_3, a second encryption unit 1225_4, and an XOR gate 1225_5.

The first encryption unit 1225_1 may encode a Tweak value (i) using a second key Key2 and the AES encryption protocol. The Tweak value (i) may be stored in a register (not shown) of the encryption engine 1225 at encoding. The modulo multiplexer 1225_2 may perform modulo multiplication on a value encoded by the first encryption unit 1225_1 and a primitive value α^{j}. Herein, the value “α” is a primitive element of a binary field, and “j ” is a sequential number of encoded write data as a power number of the primitive element. That is, the value “j” is a number of write data units that are sequentially provided.

The XOR gate 1225_3 may a bit-wise exclusive OR operation on an output τ of the modulo multiplexer 1225_2 and a plane data “a1”. The second encryption unit 1225_4 may encode an output PP of the XOR gate 1225_3 using a first key Key1 and the AES encryption protocol. The XOR gate 1225_5 may XOR an encoded value “CC” of the second encryption unit 1225_4 and the output τ of the modulo multiplexer 1225_2. As a result, encrypted data “a1” may be generated.

The foregoing assumes an encryption engine 1225 encoding write data using the AES encryption protocol. However, the inventive concept is not limited thereto.

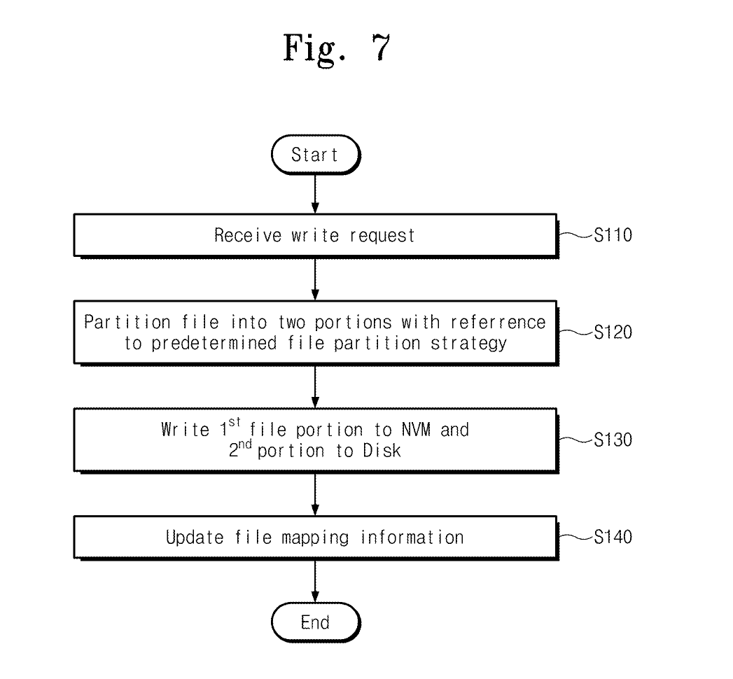

FIG. 7 is a flowchart summarizing a data management method that may be implemented using the data path controller 1210a according to an embodiment of the inventive concept. Referring to FIGS. 1 and 7, the data storage device 1200 may be used to store a write-requested file received from the host 1100 in different storage mediums following partition of the write-requested file.

The data management of FIG. 7 begins when a write request is received from the host 1100 that identifies and transfers data associated with a corresponding write-requested file (S110). The data path controller 1210a may be used to detect the incoming write request. For example, if an application running on the host 1100 or a user input initiates a write request directed to a particular file, the file system of the host may be used to open a corresponding write-requested file. That is, the file system may generate a file name and allot a file size. The file system may also be used to generate metadata defining, managing and/or controlling the write-requested file. The metadata may include control information associated with the file, recovery information necessary to the detection and/or correction of errors in the data, etc. When ready, the file system of the host 1100 will provide a write request (with an accompanying write-requested file) to the data storage device 1200. The data path controller 1210a may be used to receive the write request as well as the accompanying write-requested file from the host 1100.

Next, the path controller 1210a may be used to partition the write-requested file into two (2) file portions (S120). For example, the data path controller 1210a may partition the write-requested file into a (first) head portion and a (second) body portion. Alternatively, the data path controller 1210a may assign a sector of data having a specific position within the write-requested file to the NVM cache 1220 and remaining data to the disk storage 1240. This file partition strategy may be established according to various references. During a file partition operation, the data path controller 1210a may add a tag corresponding to the write-requested file to each resulting file portion. This allows the file portions to be readily identified and merged in response to s subsequent read operation directed to the file.

Now, the data path controller 1210a may write (e.g., program) a first file portion (e.g., a header) of the write-requested file in the NVM cache 1220, and write a second file portion (e.g., a body) of the write-requested file in the disk storage 1240 (S130). During this step, the data path controller 1210a may configure a mapping table including mapping information relating logical addresses for the write-requested file, as provided by the host 1100, with corresponding physical addresses associated with the different storage mediums (e.g., the NVM and magnetic disk) of the data storage device 1200. That is, an address of the data storage device 1200 mapped onto a logical address of a file provided from the host 1100 may include an address of the NVM cache 1220, at which the first portion of the file is to be stored, and an address of the disk storage 1240 at which the second portion of the file is to be stored. This mapping table may be stored at a buffer memory 1230.

Under the control of the data path controller 1210a, a specific memory area of the NVM cache 1220 may be updated with file mapping information (FMI) stored in the buffer memory 1230 or a separate working memory (S140). However, a storage area updated with file mapping information is not limited thereto.

With the above-described operations, a write-requested file may be partitioned and then stored in different data storage mediums of the data storage device 1200 making is nearly impossible to obtain the file data in a meaningful way using an unauthorized manner. Thus, data security for the data storage device 1200 may be markedly improved.

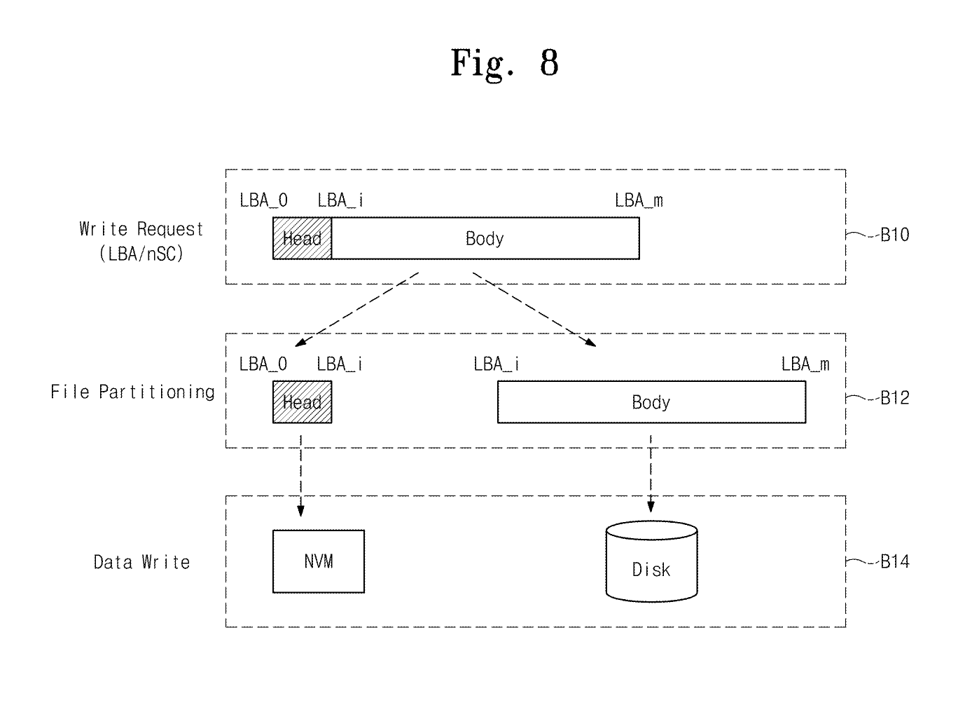

FIG. 8 is a conceptual diagram describing data flow according to the data management method of FIG. 7.

In the illustrated example of FIG. 8, block B10 shows a file provided to the data storage device 1200 in response to a write request by the host 1100. A logical address provided with the write request is assumed to start with logical address LBA_{—}0, and includes a number of sectors nSC constituting the write-requested file. The file may include a body field including payload (or user) information and a head field including control information added by the host 1100.

Then, in block B12, the data path controller 1210a partitions the write-requested file into two file portions according to a predetermined file partition strategy. For example, the file partition strategy may designate one portion of the write-requested file as the head field and another file portion as the body field. However, this is just one example of many file partition strategies that might be used.

The data path controller 1210a may be used to control linking of the first and second portions of the write-requested file. Since the first and second file portions are stored in different storage mediums using different addressing schemes, file configuration according to a read request will be readily facilitated when properly linked. Hence, the data path controller 1210a may add a tag ID or a context ID indicating that the first and second file portions when stored in the different storage mediums and enabling file portion linking. However, the first and second file portions may be identified during a subsequent read operation using address mapping schemes that do not rely on tag/context IDs.

In block B14, the data path controller 1210a stores the first portion of the write-requested file in the NVM cache 1220 and the second portion of the write-requested file in the disk storage 1240.

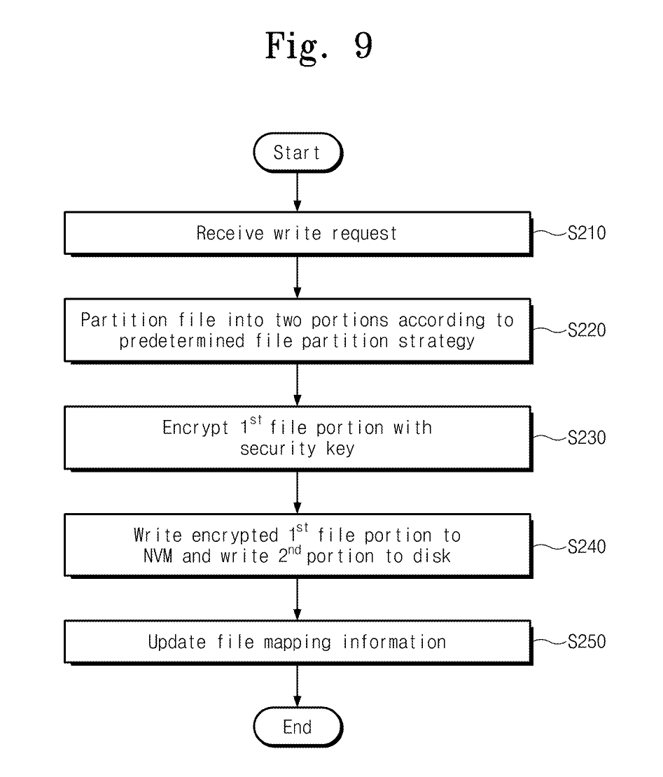

FIG. 9 is a flowchart summarizing a data management method implemented by the data path controller of FIG. 3 according to another embodiment of the inventive concept. Referring to FIG. 9, the data storage device 1200 of FIG. 1 may store a write-requested file received from the host 1100 using at least two different storage mediums. In the illustrated example of FIG. 9 it is further assumed that the first portion of the write-requested file stored in the NVM cache 1220 is encoded prior to being programmed.

Thus, upon receiving a write request including a write-requested file from the host 1100, the data path controller 1210a may be used to decode a command queue associated with the host interface 1213 (S210). As the command queue is decoded, the data path controller 1210a will recognize the write request and the write-requested file (e.g., data and addresses) received form the host 1100.

Next, the data path controller 1210a may be used to partition the write-requested file according to a predetermined file partition strategy (S220). For example, the data path controller 1210a may partition the write-requested file into first and second file portions. Here again, the first portion may correspond to a head portion of the write-requested file, and the second portion may correspond to a body thereof. The data path controller 1210a may add a tag corresponding to the write-requested file to the first and second portions, respectively. The added tag may make it easy to configure a file at a read request.

The first portion of the write-requested file may now be encoded (or, encrypted) by the data path controller 1210a (S230). Alternatively, the first portion of the write-requested file may be encoded (or, encrypted) by a memory controller 1220a. (See, FIG. 5). When a write request directed to the first portion is transferred to the NVM cache 1220 by the data path controller 1210a, a key management block 1222 of the memory controller 1220a may read a security key from a nonvolatile memory 1220b based on address information. The security key and the first portion may be provided to an encryption engine 1225. The encryption engine 1225 may encode (or, encrypt) the first portion using the security key.

Data corresponding to the first portion encoded/encrypted may then be written in the nonvolatile memory 1220b, while the second portion may be written to the disk storage 1240 (S240). During these steps, the data path controller 1210a may configure a mapping table including mapping information between a logical address corresponding to a file address provided from the host 1100 and a physical address of storage mediums (NVM and magnetic disk) of the data storage device 1200. That is, an address of the data storage device 1200 mapped onto a logical address of a file provided from the host 1100 may include an address of the NVM cache 1220, at which the first portion of the file is to be stored, and an address of the disk storage 1240 at which the second portion of the file is to be stored. This mapping table may be stored at a buffer memory 1230.

Under the control of the data path controller 1210a, a specific memory area of the NVM cache 1220 may be updated with file mapping information (FMI) stored in the buffer memory 1230 or a separate working memory (S250). However, a storage area being updated with the file mapping information FMI is not limited thereto.

With the above-described operations, a file may be partitioned and stored in different data storage mediums of the data storage device 1200. In particular, one portion of a write-requested file to be stored in the NVM cache 1220 may be encoded (or encrypted). Thus, the security on the write-requested file may be further enforced.

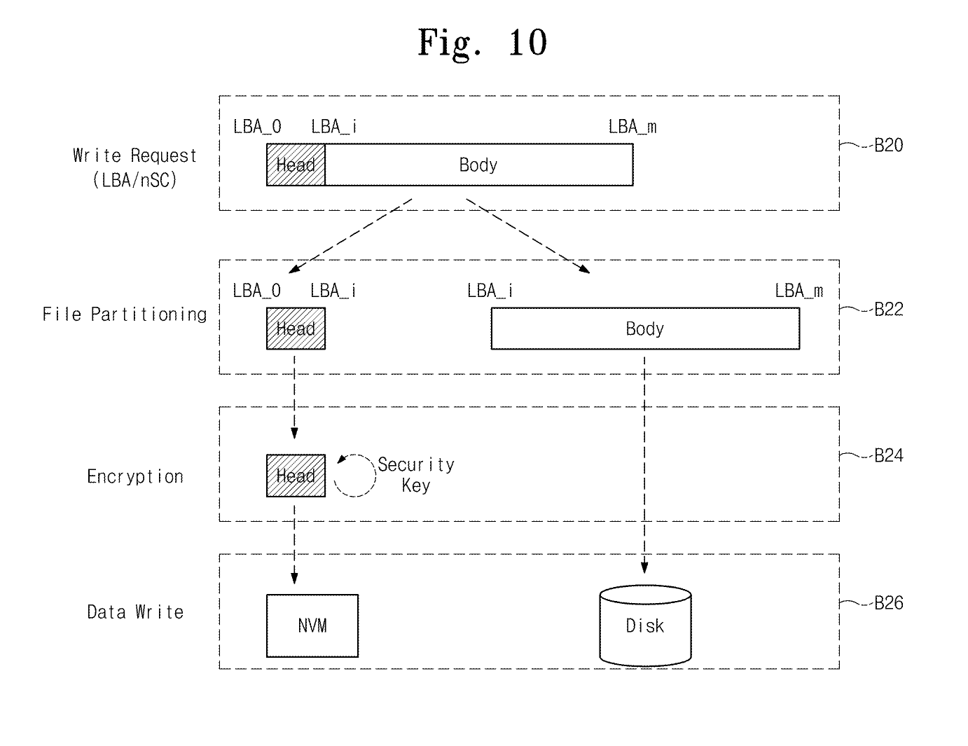

FIG. 10 is a conceptual diagram describing data flow according to the data management method of FIG. 9.

Within FIG. 10, a block B20 conceptually shows a file provided to the data storage device 1200 according to a write request made by the host 1100. A logical address provided with the write request is assumed to have a start logical address LBA_{—}0 and include a number of sectors nSC constituting the write-requested file. The file may include a body field including user information and a head field including control information added by the host 1100.

In block B22, a data path controller 1210a may be used to partition the write-requested file into two portion s according to a predetermined file partition strategy. For example, the file partition strategy may be proceed such that the write-requested file is partitioned into the head field having a relatively small size (e.g., one sector) and the body field having a relatively large size (e.g., many sectors).

The data path controller 1210a may perform linking of the first and second portions of the write-requested file. Since the first and second portions are stored in different storage mediums using different addressing manners, file configuration according to a read request must be facilitated by some linking mechanism or algorithm. For example, the data path controller 1210a may add a tag ID (T1 and T2) or a context ID indicating that the first and second portion s stored in different storage mediums are associated with a file and enabling linking to be performed easily at a read operation. However, it will be understood that the first and second portions may be designated to be recognized as parts of a unitary file using address mapping without the aid of tag/context IDs.

In block B24, the first portion of the write-requested file may be encoded (or, encrypted) by the data path controller 1210a or a memory controller 1220a. (See, FIG. 5). When a write request directed to the first portion is transferred to the NVM cache 1220 by the data path controller 1210a, a key management block 1222 of the memory controller 1220a may read a security key from a nonvolatile memory 1220b based on address information. The security key and the first portion may be provided to an encryption engine 1225. The encryption engine 1225 may encode (or, encrypt) the first portion using the security key.

In block B26, the data path controller 1210a may now store the encoded/encrypted first portion of the write-requested file in the NVM cache 1220 and the second portion of the write-requested file in the disk storage 1240.

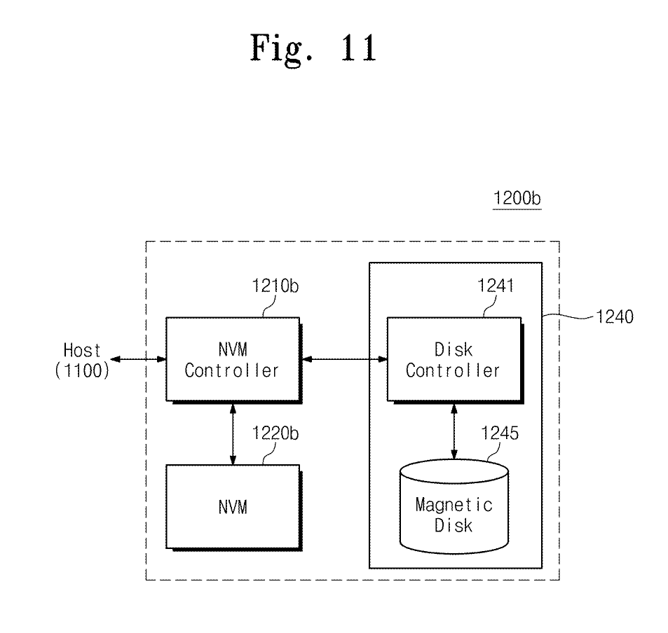

FIG. 11 is a block diagram illustrating a data storage device according to another embodiment of the inventive concept. Referring to FIG. 11, a data storage device 1200b may include an NVM controller 1210b, an NVM 1220b, and disk storage 1240. The disk storage 1240 may include a disk controller 1241 and a magnetic disk 1245. Herein, the NVM controller 1210b may be configured to partition a write-requested file provided from the host 1100.

The NVM controller 1210b may decode a file write request of the host 1100. A file system of the host 1100 may assign a file name and a file size to a write-requested file. In particular, the file system may generate metadata for controlling and managing files. The metadata may be included in a file header. The NVM controller 1210b may partition the write-requested file into a plurality of portions according to a given file partition strategy. The NVM controller 1210b may store one portion of the file in the NVM 1220b and the remaining portion in the magnetic disk 1245.

The NVM 1220b may use a flash memory that stores data even at power-off, as a storage medium. For example, the NVM 1220b may include at least one of a NAND flash memory, a NOR flash memory, or a fusion memory (e.g., OneNAND® flash memory). The NVM 1220b may include a security key storage area storing a security key encoding data to be stored.

The disk controller 1241 may write data provided according to the control of the NVM controller 1210b in the magnetic disk 1245. The magnetic disk 1245 may be accessed by a sector unit at a write or read request.

Within the context of the data storage device 1220b shown in FIG. 11, the NVM controller 1210b may be used to partition the write-requested file received from the host 1100 according to defined condition(s). As before, one portion of the write-requested file may be stored in the NVM 1220b, and the remaining portion in the magnetic disk 1245. Nonetheless, upon receiving a subsequent read request, it is possible to reconstitute a coherent file using data stored in different storage devices, such as those provided by a hybrid HDD.

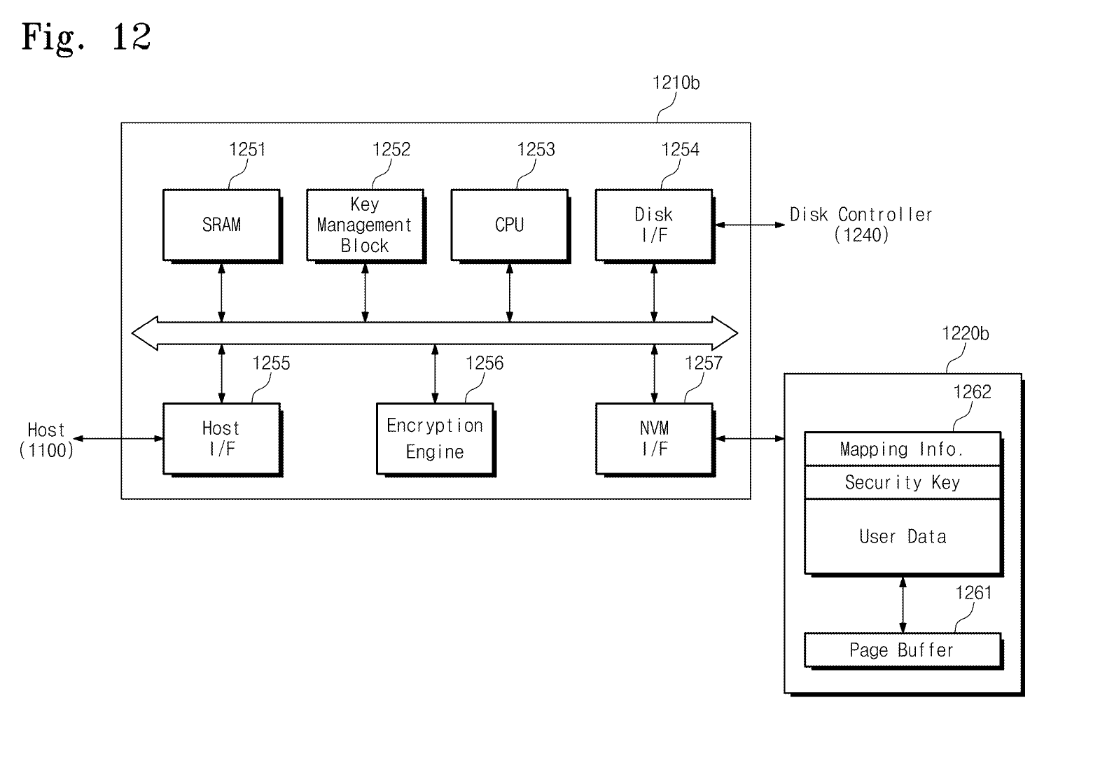

FIG. 12 is a block diagram further illustrating in one embodiment the NVM controller and NVM of FIG. 11. Referring to FIG. 12, an NVM controller 1210b may operate as a main controller of a data storage device 1200b.

The NVM controller 1210b may be configured to control an NVM 1220b.

The NVM controller 1210b may include an SRAM 1251, a key management block 1252, a CPU 1253, a disk interface 1254, a host interface 1255, an encryption engine 1256, and an NVM interface 1257.

The SRAM 1251 may be used as a working memory of the CPU 1253. For example, firmware being executed by the CPU 1253 may be loaded onto the SRAM 1251. The SRAM 1251 may be used to configure a mapping table for mapping a logical address of data provided from the host 1100 onto an NVM 1220b and a magnetic disk 1245. A flash translation layer (FTL) for driving the NVM 1220b may be loaded onto the SRAM 1251.

The key management block 1252 may provide the encryption engine 1256 with a security key for encoding write-requested data in response to a write request from the data path controller 1210a. The key management block 1252 may read a security key from a security key storage area of the NVM 1220b based on an address provided at a write request of the host 1100. The key management block 1252 may read a security key from the security key storage area of the NVM 1220b in response to a read request of the host 1100, and may provide it to the encryption engine 1256.

The CPU 1253 may perform memory management operations according to firmware. For example, the CPU 1253 may perform a function of a flash translation layer (FTL) providing an interface between the NVM 1220b and the host 1100. To perform an address translation function being another function of the FTL, the CPU 1253 may configure a mapping table on the SRAM 1251. The mapping table may be periodically updated at a mapping information area of the NVM 1220b under the control of the CPU 1253.

The CPU 1253 may be used to partition a write-requested file received from the host 1100 into at least two “write units” respectively corresponding to file portions. As above, the CPU 1253 may be used to partition the write-requested file into the two write units according to a defined file partition strategy. The CPU 1253 may add a tags indicating that two write units are parts of a common, partitioned file. The CPU 1253 may then write the two write units in the NVM 1220b and the magnetic disk 1245. In particular, the CPU 1253 may control the key management block 1252 and the encryption engine 1256 to encrypt one write unit to be written in the NVM 1220b.

The encryption engine 1256 may encode write-requested data or read-requested data based on a security key provided from the key management block 1252. The encryption engine 1256 may encode write-requested data using a security key provided from the key management block 1252, while the encryption engine 1256 may decode read-requested data using a security key provided from the key management block 1252. The encryption engine 1256 may be formed of the AES (Advanced Encryption Standard) algorithm or a device corresponding thereto, for example.

The host interface 1255 may provide the protocol for data exchange between the host 1100 and the data storage device 1200b. The disk interface 1254 may provide the protocol for data exchange between the NVM controller 1210b and the NVM interface 1257. The NVM interface 1257 may provide the protocol for data exchange between the NVM controller 1210b and the NVM 1220b.

The NVM controller 1210b may further include an ECC block (not shown) for detecting and correcting errors of data read from the NVM 1220b. Although not shown in figure, the NVM controller 1210b according to the inventive concept may further include a ROM that stores information used to implement a file partition strategy, such as a control algorithm or recognition control procedure.

In certain embodiments, the NVM 1220b may include one or more flash memory devices. The NVM 1220b may include a cell array 1262 storing data and a page buffer 1261 writing or reading access-requested data. The cell array 1262 may include an area storing mapping information used to translate a logical address from the host 1100 into a physical address of the NVM 1220b. The cell array 1262 may further include a security key area storing a security key for encryption. The cell array 1262 may further include a user data area storing write-requested data.

Herein, certain embodiments of the inventive concept will be described under the assumption that the NVM 1220b is a NAND flash memory in which a program operation is executed following an erase operation. However, the inventive concept is not limited thereto. For example, the NVM 1220b can be formed of a PRAM, an MRAM, a ReRAM, an FRAM, a NOR flash memory, or the like.

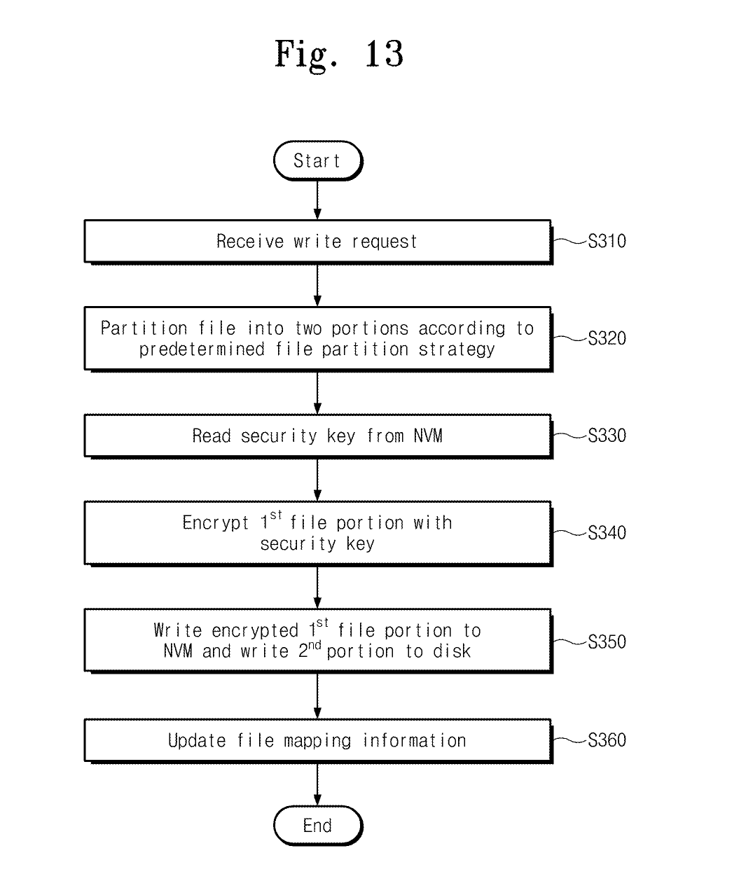

FIG. 13 is a flowchart summarizing a data management method for the NVM controller of FIG. 12 according to an embodiment of the inventive concept. Referring to FIG. 13, method steps S310, S320, S340, S350 and S360 functionally and respectively correspond to method steps S210 through S250 of FIG. 9 and will not be described in detail to avoid repetition.

However, step S330 of the method illustrated in FIG. 12 more specifically requires at least one of the security keys used to encrypt the first portion of the write-requested file be read from the NVM 1220b, where the security key read from the NVM 1220b is provided to the encryption engine 1256. Then, in operation S340, the first portion of the write-requested file may be encoded (or encrypted) by the encryption engine 1256 using the security key.

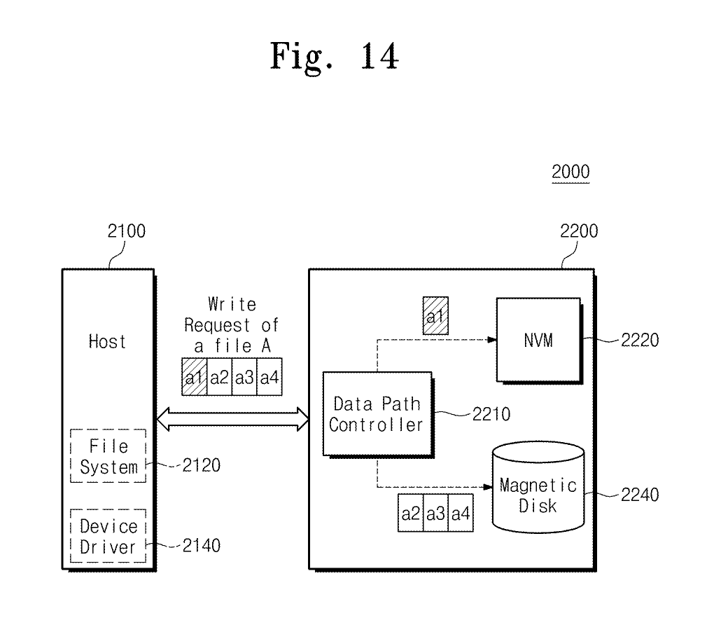

FIG. 14 is a block diagram of a user device according to another embodiment of the inventive concept. Referring to FIG. 14, a user device 2000 generally comprises a host 2100 and a data storage device 2200. As a mass stage device, the data storage device 2200 may include an NVM 2220 formed of a semiconductor memory device and a magnetic disk 2240 including a magnetic disk as a storage medium. Herein, the user device 2000 may be an information processing device such as a personal computer, a digital camera, a camcorder, a handheld phone, an MP3 player, a PMP, a PDA, or the like.

The host 2100 may be configured to generate and delete files at driving of application programs. Generating and deleting of files may be controlled by a file system 2120 of the host 2100. The host 2100 may include a volatile memory such as DRAM, SRAM, or the like and a nonvolatile memory device such as EEPROM, FRRAM, PRAM, MRAM, flash memory, or the like.

The host 2100 may generate a file, and may issue a write request on the data storage device 2200. The generated file may be transferred to the data storage device 2200 by the sector. A write request or transaction on one file may be generated by the cluster.

It is assumed that writing of a file A in the data storage device 2200 is requested by the host 2100. Further, it is assumed that the file A is formed of four sectors a1, a2, a3, and a4. Herein, the sector a1 may correspond to a file header and the sectors a2, a3, and a4 may correspond to a file body.

During a write operation directed to a requested file, the file system 2120 or a device driver 2140 of the host 2100 may assign the four sectors of the file A to a storage medium of the data storage device 2200. For example, the file system 2120 or the device driver 2140 may assign the sector a1 to the NVM 2220 and the sectors a2, a3, and a4 to the magnetic disk 2240. At assigning of sectors to storage mediums, it is possible to add tags to sectors, respectively.

If a write request on the file A is provided to the data storage device 2200, the data storage device 2200 may write a file header and a file body at locations directed by the file system 2120 or the device driver 2140. For example, a data path controller 2210 of the data storage device 2200 may store the sector a1 corresponding to the file header in the NVM 2220. The data path controller 2210 of the data storage device 2200 may store the sectors a2, a3, and a4 corresponding to the file body having a relatively larger capacity in the magnetic disk 2240. The data path controller 2210 may encode (or, encrypt) data to be stored in the NVM 2220 using a security key.

As before, because separate portions of a unitary file—as defined by the file system 2120—is partitioned and stored in different storage mediums it is nearly impossible to obtain by unauthorized manes a meaningful representation of the file data from the different storage mediums. This markedly improves data security, particularly when encoding or encryption of at least one file portion is used.

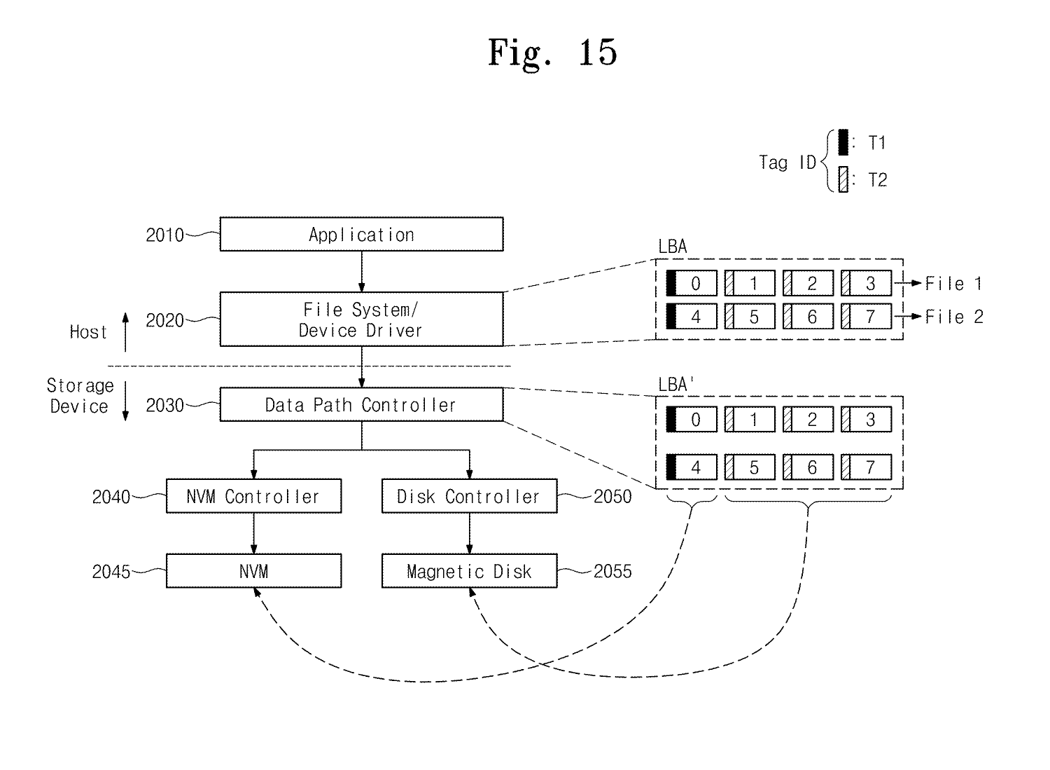

FIG. 15 is a conceptual diagram of a software architecture that may be sued by the user device of FIG. 14.

Referring to FIG. 15, software controlling the generation and handling of a file by the user device 2000 may be hierarchically divided into higher level layer(s) and a lower level layer(s). Higher level software layers may include an application program 2010 and a file system 2020 operating within the host 2100. Lower level layers may include software controlling the data path controller 2030, nonvolatile memory (NVM) controller 2040, nonvolatile memory 2045, disk controller 2050, and magnetic disk 2055.

The application program 2010 may correspond to the uppermost program driving the user device 2000. The application program 2010 may be a program that is designed to enable a user or another application program to directly perform a specific function. The application program 2010 may use an operating system (OS) and services of other support programs. An access to the data storage device 2200 may be requested by the application program 2010 and the operating system OS.

The file system/device driver 2020 may add a tag ID directing a storage medium to write-requested data. For example, when a write request on a file File1 corresponding to logical addresses LBA0 to LBA3 is transferred to the data storage device 2200, a tag ID T1 may be added to a sector corresponding to the logical address LBA0. The file system/device driver 2020 may add a tag ID T2 to sectors corresponding to logical addresses LBA1 to LBA3.

The data path controller 2030 may process an access requested by a file unit from the file system/device driver 2020. The data path controller 2030 may be used to partition the write-requested file received from the host 2100 into two write units, as previously described. The data path controller 2030 may write one of the two write units to the NVM 2045 and the other to the magnetic disk 2055. In response to a subsequent read request received from the host 2100 and indicating the file, the data path controller 2030 may be used to read the requisite data units corresponding to the read-requested file from the NVM 2045 and the magnetic disk 2055, respectively. The data path controller 2030 may merge two data units read from the NVM 2045 and the magnetic disk 2055 to provide it to the host 2100.

To manage a file as described above, the data path controller 2030 may configure a mapping table as illustrated at a right side of FIG. 15. For example, the data path controller 2030 may configure a new mapping table to access the NVM 2045 and the magnetic disk 2055. Alternatively, the data path controller 2030 may bypass a logical address provided from the host 2100 to the NVM controller 2040 and the disk controller 2050 without configuring of a new mapping table.

The NVM controller 2040 may convert an address suitable for the NVM 2045 in response to a request on a read/write operation from the data path controller 2030. The NVM 2045 such as a flash memory may not support overwriting. For the flash memory, an erase operation may be performed prior to writing of data. A flash translation layer (FTL) may be used between a file system and a flash memory to hide this erase operation. The NVM controller 2040 may include functions of the FTL.

The NVM controller 2040 may write data, provided from the data path controller 2030, in the NVM 2045. At this time, write-requested data can be encoded (or, encrypted) using a security key in addition. The NVM controller 2040 may provide the data path controller 2030 with read-requested data. As a result, data LBA0 and LBA4 corresponding to a file header may be stored in the NVM 2045.

The disk controller 2050 may write data provided from the data path controller 2030 in the magnetic disk 2055. The disk controller 2050 may read data being read requested from the magnetic disk 2055 to provide it to the data path controller 2030. As a result, data LBA1 to LBA3 and LBA5 to LBA7 corresponding to a file body may be stored in the magnetic disk 2055.

The data path controller 2030 included in the above-described software architecture may partition and store one file in different storage mediums. In response to a subsequent read request, the data units may be merged by the data path controller 2030 to provide the requested file to the host 2100. Although data in one of the different storage mediums may be successfully hacked or leaked via a security attack, it is very difficult to meaningfully configure the file data. Thus, it is possible to improve the security using the data storage device 2200 according to embodiments of the inventive concept.

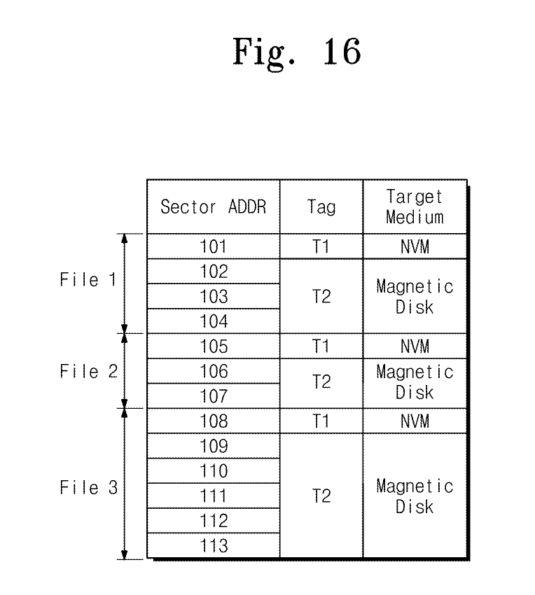

FIG. 16 is a table listing in one exemplary form a file partition method as executed by the file system 2120 and/or the device driver 2140 of FIG. 14. Referring to FIGS. 14 and 16, the file system 2120 and/or device driver 2140 may add tag IDs T1 and T2 directing storage mediums of a data storage device 2200 with respect to sectors of a write-requested file.

The file system 2120 or the device driver 2140 may add a tag ID T1 directing an NVM 2220 to a sector 101, corresponding to a header, from among sectors 101, 102, 103, and 104 of the write-requested file File1. On the other hand, the file system 2120 or the device driver 2140 may add a tag ID T2 directing a magnetic disk 2240 to sectors 102, 103, and 104, corresponding to a body, from among the sectors 101, 102, 103, and 104 of the write-requested file File1.

The above-described operation may be applied to write-requested files File2 and File3. A sector location, to which a tag ID T1 directing the NVM 2220 is added, may be modified or changed variously according to a defined file partition strategy. A table for mapping a file address according to a file partition operation may be used in addition. The data storage device 2200 may store a partitioned file in the NVM 2220 and the magnetic disk 2240 under the control of the file system 2120 and/or device driver 2140. During a subsequent read mode, a read-requested file may be read from the NVM 2220 and magnetic disk 2240 according to a tag ID provided by the host 2100.

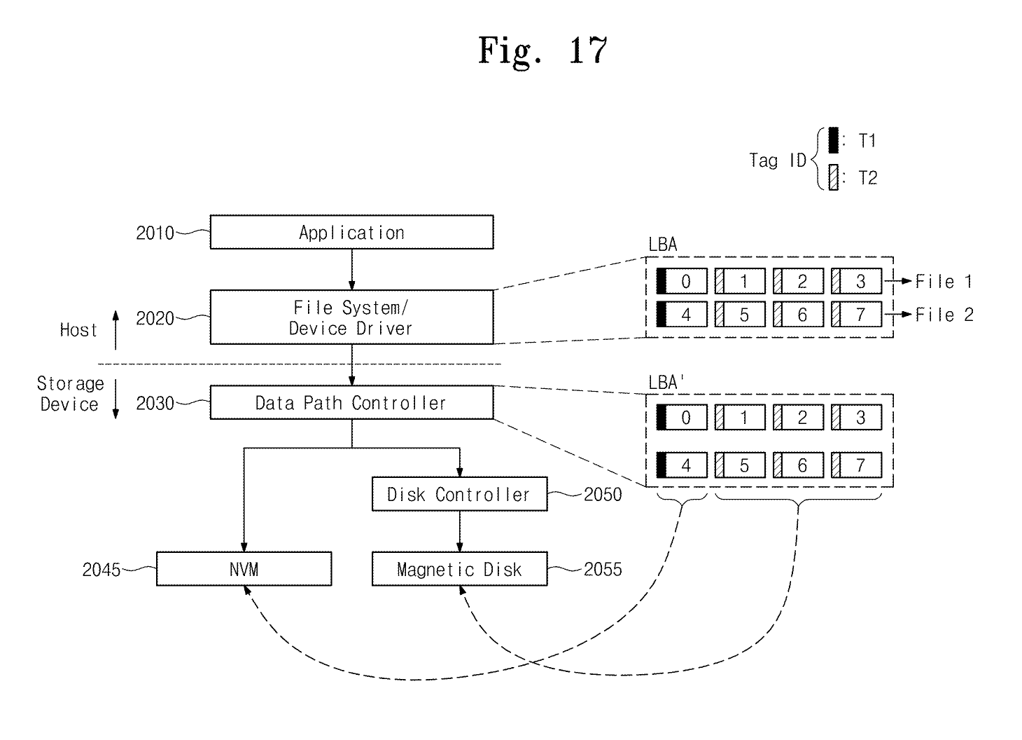

FIG. 17 is a block diagram illustrating one possible software architecture for the user device of FIG. 16 according to another embodiment of the inventive concept.

Referring to FIG. 17, only the omission of a particular NVM controller 2040 distinguishes the architecture of FIG. 17 from that of FIG. 15. Hence, the data path controller 2030 may directly process an access request made by the file system and/or device driver without recourse to a separate NVM controller.

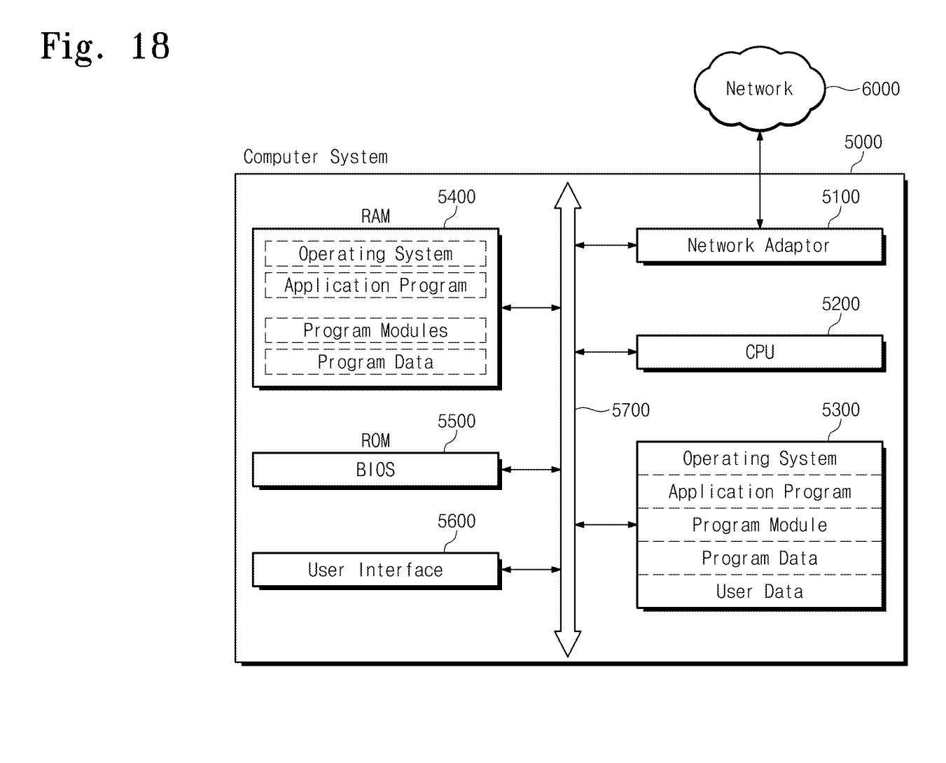

FIG. 18 is a block diagram illustrating a computational system including a data storage device according to embodiments of the inventive concept.

A computational system 5000 may include a network adaptor 5100, a CPU 5200, a mass storage device 5300, a RAM 5400, a ROM 5500, and a user interface 5600 which are electrically connected to a system bus 5700.

The network adaptor 5100 may provide an interface between the computational system 5000 and external devices and/or networks. The CPU 5200 may control an overall operation for driving an operating system and an application program which are resident on the RAM 5400. The mass storage device 5300 may store data required by the computational system 5000. For example, the mass storage device 5300 may store an operating system driving the computational system 5000, an application program, various program modules, program data, user data, and the like.

The RAM 5400 may be used as a working memory for the computational system 5000. Upon booting, the operating system, the application program, the various program modules, and program data needed to drive programs and various program modules read out from the mass storage device 5300 may be loaded on the RAM 5400. The ROM 5500 may store a basic input/output system (BIOS) which is activated before the operating system is driven upon booting. Information exchange between the computational system 5000 and a user may be made via the user interface 5600. In addition, the computing system 5000 may further include a battery, a modem, and the like. Although not shown in FIG. 18, the computational system 5000 may further include an application chipset, a camera image processor (CIS), a mobile DRAM, and the like.

As described above, the mass storage device 5300 may be formed of a hybrid HDD including different storage mediums. The mass storage device 5300 may be configured to partition a write-requested file and to store the resulting file portions between a nonvolatile memory and magnetic disk. Further, the mass storage device 5300 may be configured to encode/encrypt at least one of the file portions of the write-requested file. Using this approach, embodiments of the inventive concept improve data security.

A nonvolatile memory and/or a memory controller may be packed by various types of packages such as PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), System In Package (SIP), Multi Chip Package (MCP), Wafer-level Fabricated Package (WFP), Wafer-Level Processed Stack Package (WSP), and the like.

The above-disclosed subject matter is to be considered illustrative, and not restrictive, and the appended claims are intended to cover all such modifications, enhancements, and other embodiments, which fall within the scope of the following claims. Thus, to the maximum extent allowed by law, the scope is to be determined by the broadest permissible interpretation of the following claims and their equivalents, and shall not be restricted or limited by the foregoing detailed description.

What is claimed is:

1. A data managing method controlling a data storage device including a first storage medium and a second storage medium, the data managing method comprising:
receiving a write request and a corresponding write-requested file from a host;
partitioning the write-requested file into a first portion and a second portion; and
storing the first portion in the first storage medium and storing the second portion in the second storage medium.

2. The data managing method of claim 1, wherein the first storage medium is a semiconductor nonvolatile memory device and the second storage medium is a disk storage device.

3. The data managing method of claim 2, wherein the first portion is a header of the write-requested file.

4. The data managing method of claim 2, further comprising:
encrypting the first portion before storing the first portion in the first storage medium.

5. The data managing method of claim 4, wherein encrypting the first portion comprises:
reading a security key from the first storage medium; and
encrypting the first portion using the security key.

6. The data managing method of claim 1, further comprising:
after storing the first portion in the first storage medium and storing the second portion in the second storage medium, updating mapping information correlating external address information for the write-requested file with respective address information for the first storage medium and the second storage medium.

7. The data managing method of claim 6, wherein the mapping information is stored in the first storage medium.

8. The data managing method of claim 1, wherein partitioning the write-requested file into the first portion and the second portion comprises:
adding one of a tag ID and a context ID to the first portion and the second portion to respectively identify the first portion and the second portion as being associated with the write-requested file.

9. The data managing method of claim 1, wherein the data storage device is a hybrid hard disk drive (HDD), the first storage medium comprises a nonvolatile cache including a flash memory device and the second storage medium comprises a hard disk.

10. The data managing method of claim 9, wherein storing the first portion in the nonvolatile cache comprises referencing a flash translation layer (FTL) to covert a logical sector address assigned by the host to the first portion into a corresponding physical address compatible with the flash memory device.

11. A data storage device comprising:
a nonvolatile cache including a nonvolatile memory device and a memory controller controlling the nonvolatile memory device;
a disk storage device including a magnetic disk; and
a data path controller that receives and partitions a write-requested file into a first portion and a second portion, and then, encrypts the first portion, stores the encrypted first portion in the nonvolatile cache using a first addressing scheme, and stores the second portion in the disk storage device using a second addressing scheme different from the first addressing scheme.

12. The data storage device of claim 11, further comprising:
a buffer memory that temporarily stores the write-requested file as provided from a host.

13. The data storage device of claim 12, wherein the data path controller comprises a buffer manager that controls the buffer memory.

14. The data storage device of claim 11, wherein the memory controller comprises:
a key management block that reads a security key from the nonvolatile memory device; and
an encryption engine that uses the security key to encrypt the first portion.

15. The data storage device of claim 14, wherein the nonvolatile memory device includes a data area storing mapping information for the write-requested file, the mapping information correlating a logical address provided by the host with a corresponding physical address for one of the nonvolatile cache and the disk storage device.

16. The data storage device of claim 15, wherein the data path controller generates the mapping information after storing the encrypted first portion in the nonvolatile cache and storing the second portion in the disk storage device.

17. The data storage device of claim 11, wherein the data path controller adds one of a tag ID and a context ID to the first portion and the second portion before storing the encrypted first portion in the nonvolatile cache and storing the second portion in the disk storage device.

18. The data storage device of claim 9, wherein the nonvolatile memory device includes memory cells accessed according to an erase-after-write manner.

19. A data storage device comprising:
a plurality of storage mediums; and
a data path controller controlling the plurality of storage mediums to write a first portion of a write-requested file in a first storage medium using a first addressing scheme and independently write a second portion of the write-requested file in a second storage medium using a second addressing scheme, wherein the first portion is encrypted before being written in the first storage medium.

20. The data storage device of claim 19, wherein at least one of a file system and a device driver in a host partitions the write-requested file into the first portion and the second portion according to a defined file partition strategy.
